(19) United States
(12) Patent Application Publication
(10) Pub. No.: US 2025/0162764 A1
(43) Pub. Date: May 22, 2025

(54) REFILL FOR PACKAGING AND METHOD OF MANUFACTURING

(71) Applicant: AISAPACK HOLDING SA, Vouvry (CH)

(72) Inventors: Gilles DEMAUREX, Martigny (CH); Jacques THOMASSET, Neuvecelle (FR)

(21) Appl. No.: 18/841,626

(22) PCT Filed: Apr. 5, 2023
(86) PCT No.: PCT/IB2023/053491

§ 371 Date: Aug. 26, 2024

(30) Foreign Application Priority Data
Apr. 8, 2022 (EP) 22167384.1

(51) Int. Cl. B65D 35/44; A47K 5/12; B65D 35/14

(52) U.S. Cl. CPC B65D 35/44; A47K 5/1201; B65D 35/14

(57) ABSTRACT

The invention relates to a packaging comprising a refill (2) in the form of a tubular body (4) and a reusable cap (3) providing functionalities to the packaging, the refill (2) forming the body of the packaging and comprising connection means (7) cooperating 5 with connecting means (8) of the cap (3) to ensure the closure of the packaging and its tightness once the body (4) and the cap (3) are assembled. The refill connection means are minimal and the cap connection means are complex.

### REFERENCE TO CORRESPONDING APPLICATIONS

The present PCT application claims priority to earlier European application N°EP22167384.1 filed on Apr. 8, 2022 in the name of AISAPACK HOLDING SA, the content of this earlier European application being incorporated in its entirety by reference in the present application.

### TECHNICAL FIELD

The invention lies in the field of packaging based on biosourced and/or biodegradable or/and recyclable materials. It relates more specifically to packaging with a reduced environmental impact. The invention applies to the field of packaging comprising a tubular body made from a sheet. The invention applies in particular to the field of recyclable flexible tubes intended to contain cream or paste products; or that of bottles for cosmetic products; or that of cylindrical packaging (cans, flexible pouches) to contain liquid or dry products.

### PRIOR ART

Packagings intended to contain liquid, semi-liquid, cream or paste products are known in the art, for example from publications US 2018/361412, WO 2022/047527, EP 3048064, EP3162732, JP H07 45088U and US 2017/253387.

For example, US 2018/361412 discloses a refillable container including: an outer container having an opening formed on top thereof; a cover configured to close the opening of the outer container; an inner container configured to store liquid, and a dispense pump provided on the cover and configured to pump the liquid content in the inner container and dispense the liquid content outside of the refillable container. In the disclosed refillable container, the inner container is accommodated in the outer container and is replaceable when the liquid content is used up.

WO 2022/047527 discloses a fluid dispensing container with a reloadable bag where the disclosed container includes a re-usable container body, a reloadable fluid dispenser assembly and a detachable bag unit which can be replaced with a replacement bag. Specifically, this publication discloses a reloadable fluid dispensing container which includes an openable container body and a dispenser assembly fastenable thereto so as to close the container, and it further comprises a bag unit with a spout attachable to the dispenser assembly for reloading the container with a replacement bag unit which contains fluid, whereby the bag unit is contained in the container body.

Publication EP 3048064, discloses a piercing fitment assembly mounted to a flexible container, whereby the wall of the flexible container is pulled into contact with a piercing element and the contents of the container are dispensed by piercing the wall of the container with an assembly having a fluid transfer device.

Publication EP3162732 discloses a refillable container enabling that a refilling operation is easily performed when a liquid content is used up. The refillable container includes an outer container, a lid member, an inner container, and a pump. The outer container has an opening formed in an upper part thereof and is made of plastic. The lid member is configured to close the opening of the outer container and is made of plastic. The inner container is made of paper, configured to store the liquid content therein, and replaceably accommodated in the outer container when the liquid content is used up. The pump is provided to the lid member and configured to pump up the liquid content in the inner container stored in the outer container and to dispense the liquid content to an outside of the refillable container. When the opening of the outer container is closed by the lid member, a suction tube of the pump, which is arranged below the lid member, is inserted from a suction port, which is formed in an upper surface of the inner container, into the inner container.

Publication JP H07 45088U discloses a dispenser with a refill that can be exchanged freely, and which is accommodated in a container body of a container.

Publication US 2017/253387 a bioplastic collapsible dispensing tube including a collapsible tube having walls that include a bioplastic material; a distal end of the tube that is sealed; a proximal end of the tube, opposite the distal end, that has an opening; a nozzle on the opening; and a closure for the nozzle, wherein, when the closure is opened and the tube is collapsed, flowable material inside the tube is urged out of the nozzle.

As detailed above, the known containers comprise several parts in particular container body, a container lid and on exchangeable part containing a product, wherein the exchangeable part is placed in the container body which is then closed by the container lid. The known containers are complicated to disassemble when the refillable part has to be exchanged because the container lid has to be separated from the container body for the extraction of the refillable or exchangeable part of the product. Once this part has been exchanged, the container has to be assembled again. This alone is time consuming and leads to a plurality of manipulations by the user. The product as a whole is also more expensive for its production since it comprises several parts (container body, lid, exchangeable part etc.).

### SUMMARY AND PRINCIPLE OF THE INVENTION

It is therefore an aim of the present invention to improve the known products and methods.

Another aim of the present invention is to provide products, such as a packaging, which exchangeable parts that are simple to manipulate and allow an easy exchange.

A further aim of the present invention is to provide a packaging that is simple to manipulate and cheap to produce.

A further aim of the present invention is to provide a packaging that is also simple and easy to recycle.

The invention is in the field of packaging and in particular that of tubes or bottles composed of a refill (containing the product as mentioned above) and an opening and closing system and/or dosing which is it is reusable. In the context of the invention, the reusable part is also the functional part of the packaging (opening, closing, dosage, etc.). Thus, all the functions with added value for the user are concentrated on the reusable part. In the context of the invention, the refill and the reusable part comprise connection means allowing easy assembly of the refill with the reusable part.

The invention relates more specifically to recharging and in particular to the means for connecting the refill to the reusable system. This refill is made from recyclable or biodegradable materials or from renewable resources. According to a preferred embodiment, the refill is based on cellulose and can be recycled at the end of its life in the paper industry. Preferably, the cellulose content of the refill is greater than 85%.

Alternatively, the refill is based on biodegradable resin and can be degraded in industrial composts or directly in a private compost. This embodiment is preferred for small capacity refills for which the energy associated with collecting, sorting and recycling is greater than the energy for manufacturing the biodegradable resin. This embodiment is also interesting in regions where sorting and recycling are not operational.

Alternatively, the refill is made from recycled plastic such as polyethylene (PE) or polypropylene (PP). This embodiment is interesting for refills produced in large quantities and for which the recycling sector is operational.

According to the invention, the refill comprises at least one tubular body, the first end of which is assembled on a shoulder. The second end of the tubular body is either clamped and welded to itself to form a refill in the form of a tube or alternatively a bottom is assembled on the second end of the tubular body to form a refill having the shape of a bottle or a cylindrical container.

According to the invention, the tubular body is produced by welding a sheet and comprises a so-called longitudinal weld. This embodiment is preferred when the refill is based on cellulose.

Alternatively, the tubular body is made by extrusion and does not include a longitudinal weld.

According to the invention, a so-called shoulder end piece is assembled on the tubular body. The shoulder is the functional part of the refill and allows easy connection to the reusable system.

According to a first exemplary realization of the invention, the shoulder comprises guide means which allow connection with the reusable system.

According to a second exemplary realization of the invention, the shoulder comprises controlled piercing means which allow the connection of the reusable system.

According to a third exemplary realization of the invention, the shoulder comprises connection means which combine guide means and controlled perforation means.

According to an embodiment of the invention, the connection means are assembled on the structural layer of the shoulder.

According to another embodiment of the invention, the connection means are part of the structural layer of the shoulder.

According to another embodiment, the connection means combine means assembled on the structural layer of the shoulder and means forming part of the structural layer of the shoulder.

In embodiments, the invention relates to a packaging comprising a refill in the form of a tubular body and a reusable cap providing functionalities to the packaging, wherein the refill forms the body of the packaging and comprises connection means cooperating with connection means of the cap to ensure the closure of the packaging and its sealing once the refill and the cap are assembled, the refill connection means being minimal and the cap connection means being complex.

In embodiments, the refill connection means are added by overmoulding or clipping or welding on the refill and comprise an orifice.

In embodiments, the refill connection means are created by a controlled perforation means, such as a facilitated piercing zone.

In embodiments, the connection means are a combination of added means comprising an orifice and facilitated piercing means or zone.

In embodiments, the cap is assembled to the refill by clipping, or screwing or piercing.

In embodiments, the orifice is closed by closing means before the assembly of the cap on the refill.

In embodiments, the closure means is at least one cover and/or a piercing zone and/or a functional layer.

In embodiments, the cover is fixed on the external face and/or on the internal face of the connection means.

In embodiments, the closure means comprises controlled perforation means such as an easy-piercing zone.

In embodiments, the refill is cellulose-based and comprises a cellulose content of at least 70%.

In embodiments, the refill is based on biodegradable resin or based on recyclable or recycled resin.

In embodiments, the refill includes a shoulder attached to the tubular body.

In embodiments, the structural layer forming the shoulder and the structural layer of the tubular body are of similar or identical composition(s).

In embodiments, the reusable system such as the cap performs the functions of opening and closing the packaging and/or the function of metering the product contained in the packaging.

In embodiments, a mirror and/or temperature sensors and/or interactive sensors or other sensors are integrated into the cap.

In embodiments, the packaging includes at least one functional layer inside the packaging.

In embodiments, the package is a tube or a bottle with a bottom or another equivalent product.

### BRIEF DESCRIPTION OF THE DRAWINGS

FIGS. 1 to 12 illustrate the invention relating to a packaging comprising a recyclable or biodegradable refill and a reusable opening and closing system.

FIG. 1 illustrates the concept of the invention applied to a tube.

FIGS. 2 to 11 illustrate embodiments of the refill and in particular of the connection zone with the reusable system.

FIGS. 2 to 5 illustrate embodiments of the invention according to which the refill comprises guide means facilitating the connection.

FIG. 2 illustrates a an embodiment of a refill with a guide element comprising an orifice.

FIG. 3 illustrates an embodiment of a refill with a guide element comprising an orifice and fixed to the external face of the shoulder.

FIG. 4 illustrates an embodiment of a refill with a guide element comprising an orifice and fixed to the internal face of the shoulder.

FIG. 5 illustrates an embodiment of a refill with the guide element and the structural layer of the shoulder forming a single piece.

FIGS. 6 to 9 illustrate embodiments of the invention according to which the refill comprises connection means by controlled perforation.

FIG. 6 illustrates an embodiment of a refill with connection means by controlled perforation.

FIG. 7 illustrates an embodiment of a refill with connection means by controlled perforation.

FIG. 8 illustrates another embodiment of a refill with controlled perforation connection means.

FIG. 9 illustrates another embodiment of a refill with controlled perforation connection means.

FIGS. 10 and 11 illustrate embodiments of the invention according to which the refill comprises connection means which combine guide means and controlled perforation means.

FIG. 10 illustrates a top view of an embodiment of a refill which comprises guide means and controlled perforation means which allow its connection to the reusable system.

FIG. 11 illustrates an embodiment of a refill which comprises guide means and controlled perforation means which allow its connection to the reusable system.

FIG. 12 illustrates the concept of the invention applied to a bottle with a metering pump.

### DETAILED DESCRIPTION

1: packaging
2: refill
3: reusable system such as a cap, a dosing pump etc.
4: tubular body
5: longitudinal welding
6: shoulder
7: refill connection means
8: cap connection means
9: Opening-closing means
10: structural part
11: operculum or cover
12: end of the shoulder
13: assembly area
14: controlled perforation means, such as an easy piercing zone
15: bottom
16: functional layer
17: end weld
18: hole

The invention relates to packaging comprising a reusable system 3 and a refill 2 based on recyclable or biodegradable materials or from renewable resources.

According to a preferred embodiment, the refill 2 is based on cellulose and has a cellulose content allowing it to be recycled in the paper industry. Advantageously, the cellulose content of the refill 2 is greater than 70% and preferably greater than 85% and ideally greater than 90%.

According to an alternative embodiment, the refill 2 is based on biodegradable resin, which is advantageous for refills 2 of small capacity for which the collecting, sorting and recycling operation presents an unfavorable carbon balance. According to an alternative mode, the refill 2 is based on recyclable or recycled resin. Advantageously the refill 2 is based on high density polyethylene or based on polypropylene.

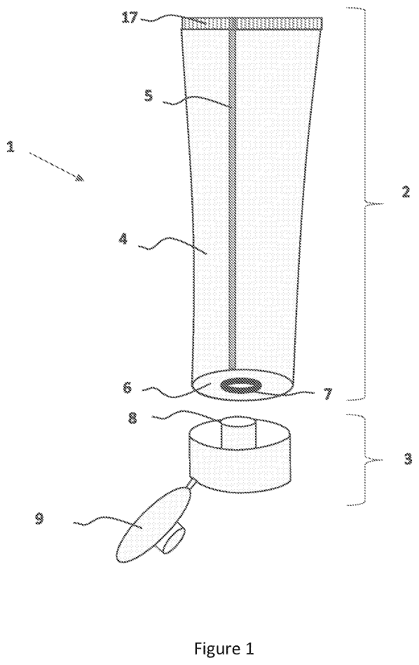

FIG. 1 illustrates an embodiment of the invention. FIG. 1 illustrates a tube 1 intended to contain and deliver, for example, viscous or pasty products such as creams for body care or toothpastes for oral hygiene.

According to the invention, the tube 1 results from the connection between a refill 2 which can be recycled or biodegraded and a reusable system 3 called a cap in the description of the invention. The reusable cap 3 provides functionalities such as the opening and closing of the packaging, the dosage of the product, the connectivity with the refill, the ease of use, etc.

The refill 2 illustrated in FIG. 1 comprises a tubular body 4 with a possible longitudinal weld 5 resulting from the manufacturing process; a shoulder 6 assembled at the end of the tubular body 4. The second end of the refill 2 is closed by flattening the second end of the tubular body 4 and welding in order to form the end weld 17.

According to the invention the refill 2 comprises connection means 7 cooperating with the connection means 8 of the cap 3. The connection means 7 of the refill are minimal, such as for example they comprise a minimal number of parts and/or parts that are as small as possible, to allow recycling of the refill and reduce its carbon footprint. Conversely, the connection means 8 of the cap 3 can be complex because this part of the packaging is intended to be reused, which means that the connection means 8 may comprise several parts and/or the size of said parts many not be minimal.

According to the invention, the reusable system 3 (also named “cap”) is a part of the robust packaging ensuring, for example and in a non-limiting manner, the functions of opening and closing the packaging or even the dosing function. According to the invention, other functions with high added value can be integrated into the reusable system 3. Thus, depending on the applications, a mirror or temperature sensors or even interactive sensors can be integrated into the cap 3 to guarantee, for example, the authenticity of the product and/or interact with a smartphone to inform the consumer. Thus, according to the invention, part 3 of the packaging with high added value is reusable a large number of times, which significantly reduces the environmental impact of the packaging.

According to the invention, the reusable system 3 comprises at least connection means 8 paired with the connection means 7 of the refill. According to the invention and with the aim of minimizing the ecological impact of the packaging, the connection means 7 of the refill 2 are minimal while the complexity of the connection system is transferred to the reusable system or part 3 of the packaging. Thus according to the invention, the refill 2 comprises the strict necessary at the level of the connection means 7. Examples of these means will be described later in the description of the invention.

FIG. 2 illustrates a first embodiment of the invention according to which the connection means 7 of the refill 2 comprise guide means such as the orifice 18 which cooperate with the connection means 8 of the cap 3 during assembly.

The refill 2 illustrated in FIG. 2 comprises a tubular body 4 assembled by welding on a shoulder 6. The structural layer 10 forming the shoulder 6 and the structural layer of the tubular body 4 are of similar if not identical composition to allow the recycling of the refill 2. Thin functional layers can be used on the inside of the tubular body and the shoulder to provide barrier properties (gas, liquid) necessary for the preservation of the packaged product; as well as the manufacture of the refill 2 (for example weldability between the body 4 and the shoulder 6).

The upper part of the refill 2 represented in FIG. 2 comprises connection means 7 which cooperate with the connection means 8 of the reusable cap 3. In particular, the connection means 7 are added by overmolding or clipping or welding onto the structural layer 10 or by other equivalent means. The connection means 7 have an orifice 18 intended to guide the connection means 8 of the cap 3 during assembly; the connection means have a geometry adapted to allow the fixing of the cap 3 by clipping and ensuring the seal between the cap 3 and the refill 2. A cover 11 is welded to the outer face of the connection means 7 in order to close the hole 18 and seal the refill before opening. The lid cover 11 also serves as a tamper evident indicator of the refill. The cover 11 is removed, for example by peeling, before the assembly of the cap 3 or it can be pierced by the assembly. In one embodiment, the connection means illustrated in FIG. 2 comprise a thread for assembly of the cap 3 by screwing.

The connection means 7 illustrated in FIG. 2 are also used to protect the edges of the structural layer 10 at the level of the shoulder orifice 6. This protection is particularly advantageous when the refill is based on cellulose or based on material sensitive to moisture or liquid products. Equivalent means, not shown, can be used to protect the ends 12 of the structural layer 10 of the shoulder 6, for example a welding barrier layer.

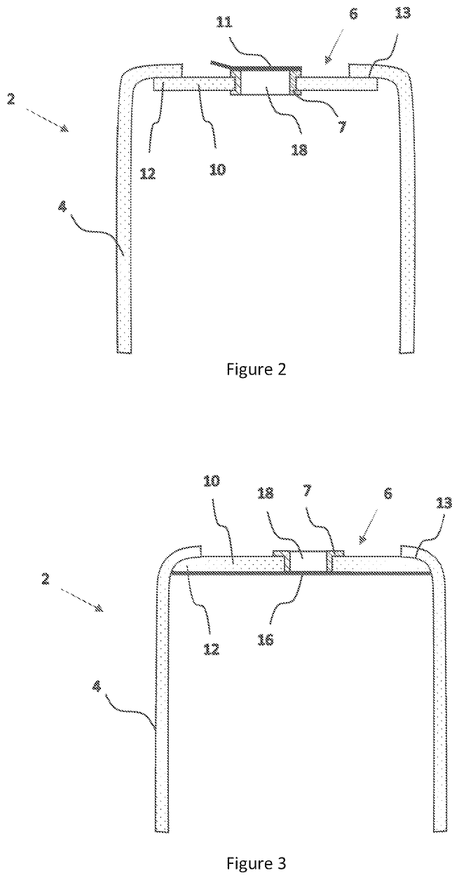

FIG. 3 illustrates a refill 2 having connection means 7 fixed on the external face of the refill, namely on the shoulder 6. Advantageously, the connection means 7 are assembled by welding or by other equivalent means. The connection means 7 comprise a threaded hole 18 which makes it possible to screw the cap 3 during assembly. When the cap 3 is screwed on, the functional layer 16 forming the internal layer of the refill is perforated by the connection means 8 of the cap 3. The functional layer 16 which covers the internal face of the refill and guarantees the preservation of the product before opening is perforated by the connection means 8 of the cap 3. In another embodiment, the connection means 7 illustrated in FIG. 3 comprise an orifice without a thread for assembly by clipping of the cap 3.

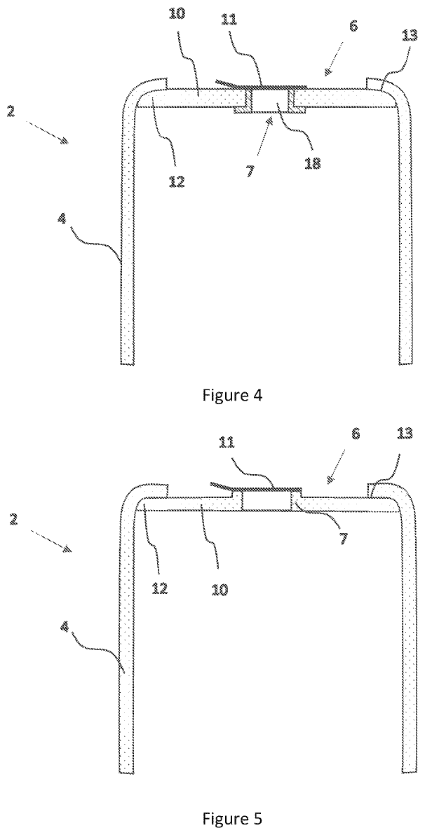

FIG. 4 illustrates another example according to which the connection means 7 are fixed on the internal face of the refill, on the shoulder 6. Advantageously the connection means 7 are fixed by welding or by other equivalent means. The connection means 7 comprise an orifice which serves as a guide for the connection means 8 of the cap 3 and allows assembly by screwing or clipping as explained in the previous examples.

According to a preferred embodiment, the refill 2 illustrated in FIGS. 2 to 4 is based on cellulose and comprises the connection means 7 making it possible to guide and fix the cap connection means. The refill 2 comprises a tubular body 4 connected by welding or gluing to a shoulder 6 closing one end of said tubular body. The shoulder 6 comprises the connection means 7 and optionally a cover 11. The connection means 7 are for example means facilitating screwing or clipping. During the operation of connecting the refill 2 to the reusable system or part 3, the cover 11 is removed or pierced by the connection device 8. In the example illustrated in FIG. 4, the refill 2 consists mainly of a layer structural based on cellulose 10 which means that at the end of its life, the refill 2 can be recycled in the paper industry. The refill 2 can also include functional layers (not shown), for example of thin thickness, which allow the preservation of sensitive products in the packaging (impermeability to liquids, gas, etc.).

FIG. 5 illustrates another embodiment of the invention according to which the connection means 7 and the structural layer 10 of the shoulder 6 are formed from a single and same layer. This embodiment of the invention is particularly suitable for the production of refills in biodegradable resin or in recycled resin, the shoulder 6 of which can be molded by injection or compression. Thus, for refills 2 made of polyethylene or polypropylene, for example, this embodiment will be preferred.

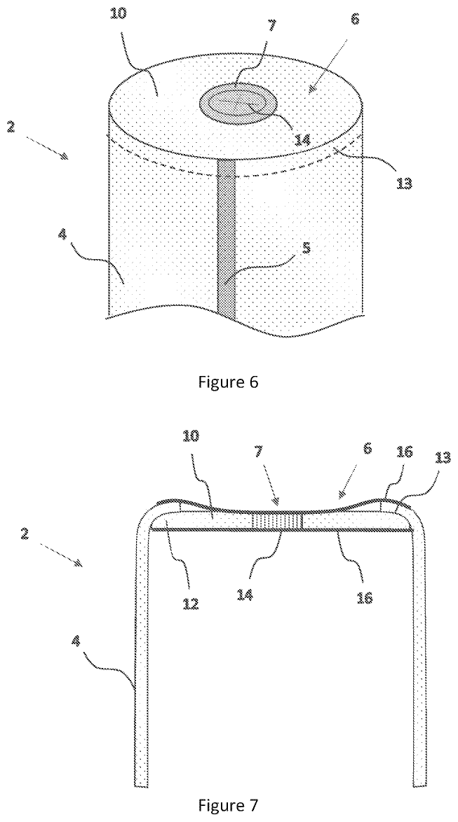

FIG. 6 illustrates another exemplary embodiment of the invention, according to which the refill 2 comprises controlled perforation means 14 which cooperate with the connection means 8 of the cap. According to this embodiment of the invention, the structural layer 10 of the shoulder comprises controlled perforation means 14 which cooperate with the connection means 8 of the cap 3. The controlled perforation means 14 are for example tear lines oriented, partial perforation lines or partial die lines. These controlled perforation means 14 are made with known methods, either for example mechanically using cutting or punching tools, or either for example by means of a laser beam which makes it possible to select the cut layers; or either by any other equivalent process making it possible to obtain such a result.

FIG. 7 illustrates an embodiment of a refill 2 comprising controlled perforation means 14. According to this embodiment, only the structural layer 10 has controlled perforation means 14, the internal and external functional layers of thin thickness 16 which cover the controlled perforation zone 14 retain their integrity to guarantee the preservation of the packaged product.

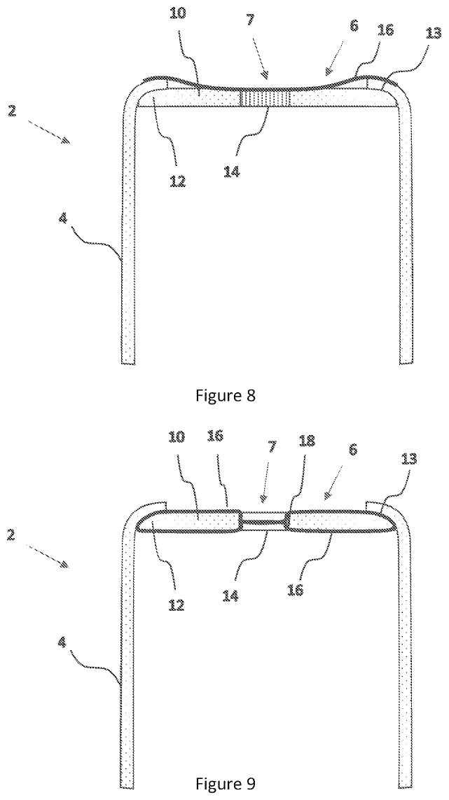

FIG. 8 illustrates another example of refill 2 comprising controlled perforation means 14. In this example, the outer functional layer 16 covers the controlled perforation zone 14 and provides the barrier properties of the packaging. According to another example not illustrated, the functional layer 16 is located only on the internal face of the packaging. This embodiment corresponds to that of FIG. 7 in which the layer 16 illustrated in FIG. 8 is removed.

FIG. 9 illustrates another example of refill comprising controlled perforation means 14. In this example, the perforation of the thin functional layers 16 is controlled by the diameter of the orifice 18 made in the structural layer 10.

According to a preferred embodiment, the refill 2 illustrated in FIGS. 6 to 9 is based on cellulose and comprises connection means 7 having a controlled perforation means 14. The controlled perforation means 14 are created for example by pre-cut lines partial or by partial perforations. The connection means 7 of the refill are paired with the perforation and connection means 8 of the reusable system 3 of the packaging 1.

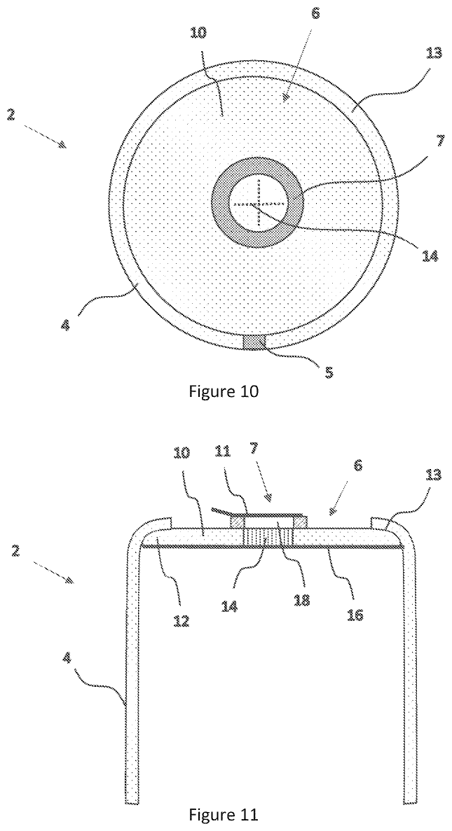

FIG. 10 illustrates a top view of another refill embodiment comprising guide means 7 and controlled perforation means 14 to facilitate connection with the cap 3. The refill comprises guide means 7 which facilitate connection and sealing with the cap 3, as well as controlled perforation means in the form of oriented tear vectors 14.

FIG. 11 illustrates another embodiment of the refill with guide means 7 fixed to the upper face of the structural layer 10 of the shoulder 6. A cover 11 removed during connection closes the orifice 18 of the means guide 7. Advantageously the guide means 7 comprise a female thread inside the orifice for screwing the connection means 8 of the cap 3. Alternatively, the orifice 18 is smooth and the cap 3 is fixed by clipping. The controlled perforation means 14 are located in the structural layer 10 of the shoulder 6.

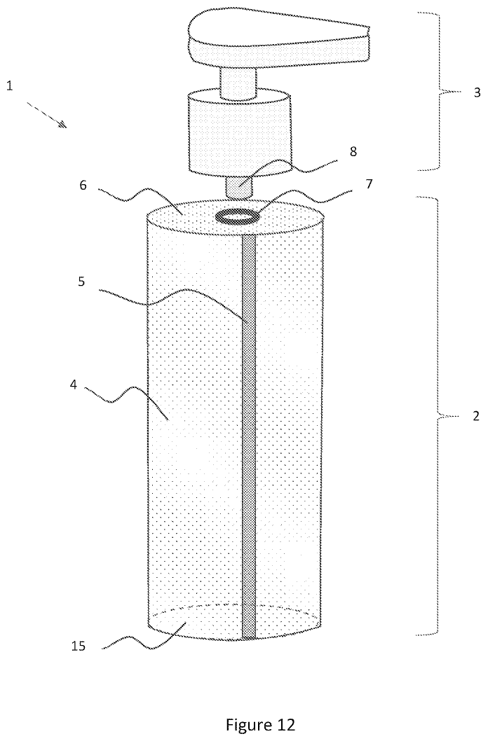

FIG. 12 illustrates an embodiment of a bottle 1 formed by a refill 2 and a reusable metering pump 3. The refill 2 comprises a bottom 15, a tubular body 4 and a shoulder 9 comprising connection means 7. The reusable system 3 which performs at least the metering, opening and closing functions also comprises connection means 8 paired with the connection means 7. In the example illustrated in FIG. 12, the reusable part 3 of the packaging comprises a metering pump to control the quantity of product delivered.

According to the invention illustrated by FIGS. 1 to 12, the refill 2 is preferably based on cellulose and is recycled in the paper industry. Alternatively, the refill 2 is made of polyethylene such as HDPE (high density polyethylene) and is recycled in the HDPE sector. According to another example, the refill is made of PP (polypropylene) and is recycled in the PP sector. The refill 2 is formed of a tubular body 4 and comprises at least connection means 7 allowing the refill to be associated with a reusable system 3.

According to the invention, the tubular body 4 is advantageously made by welding or gluing a cellulose-based sheet. The tubular body 4 is preferably made using an outer band and an inner band connecting the ends of the sheet arranged end to end. These tubular bodies and their manufacturing methods are described for example in the publications EP2007567, EP2004389, EP2004506 and EP2630052. Alternatively, when the refill is based on resin such as polyethylene or polypropylene, the tubular body 4 can be made by butt welding with an internal and/or external band; or by covering the ends of the sheet. Alternatively, the tubular body can be extruded.

According to the invention, the connection means 7 comprise guide means and/or assembly means by screwing or clipping and/or sealing means with the connection means 8 of the reusable system 3. The means of connection 7 are advantageously manufactured by molding to present the necessary tolerances to the requirements of the assembly. Thus preferably the connection means 7 are made of molded resin such as polyethylene, polypropylene, PVOH or biodegradable resin. The choice of resins is made according to the nature of the refill. So when the refill is cellulose-based, a resin like PVOH is preferred because it is already used in the paper industry and its recycling. Similarly, if the refill is made from recycled polyethylene, the connection means 7 will preferably be made from recycled polyethylene as well.

The embodiments described in the present application are by way of illustrative examples and should not be considered as limiting. Other embodiments may make use of means equivalent to those described for example. Execution modes can also be combined with each other depending on the circumstances, or means used in one mode can be used in another mode.

Exemplary embodiments have been described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined not solely by the claims. The features illustrated or described in connection with one exemplary embodiment may be combined with the features of other embodiments. Such modifications and variations are intended to be included within the scope of the present invention. A number of problems with conventional methods and systems are noted herein and the methods and systems disclosed herein may address one or more of these problems. By describing these problems, no admission as to their knowledge in the art is intended. A person having ordinary skill in the art will appreciate that, although certain methods and systems are described herein with respect to several non-limiting embodiments, the scope of the present invention is not so limited. Moreover, while this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. Packaging comprising a refill (2) in the form of a tubular body (4) and a reusable cap (3) providing functionalities to the packaging, the refill (2) forming the body of the packaging and comprising connection means (7) cooperating with connection means (8) of the cap (3) to ensure the closure of the packaging and its sealing once the refill (2) and the cap (3) are assembled, said refill connection means (7) being minimal and said cap connection means (8) being complex.

2. Packaging according to claim 1, wherein the connection means (7) of the refill are added by molding or clipping or welding on the refill (2) and comprise an orifice (18).

3. Packaging according to claim 1, in which the connection means (7) of the refill are created by a facilitated piercing zone.

4. Packaging according to claim 1, in which the connection means (7) are a combination of added means comprising an orifice (18) and facilitated piercing means.

5. Packaging according to claim 1, wherein the cap (3) is assembled to the refill by clipping or screwing or piercing.

6. Packaging according to claim 2, wherein the orifice (18) is closed by closing means (11, 14, 16) before the assembly of the cap (3) on the refill (2).

7. Packaging according to claim 6, the closure means is at least one cover (11) and/or a controlled perforation means (14) and/or a functional layer (16).

8. Packaging according to claim 7, wherein the lid is fixed on the outer face and/or on the inner face of the connection means (7).

9. Packaging according to claim 6, in which the closure means comprises a controlled perforation means (14).

10. Packaging according to claim 1, in which the refill is based on cellulose and comprises a cellulose content of at least 70%.

11. Packaging according to claim 1, wherein the refill (2) is based on biodegradable resin or based on recyclable or recycled resin.

12. Packaging according to claim 1, wherein the refill (2) comprises a shoulder (6) fixed to the tubular body (4).

13. Packaging according to claim 12, in which the structural layer (10) forming the shoulder (6) and the structural layer of the tubular body (4) are of similar or identical composition.

14. Packaging according to claim 1, in which the cap (3) performs the functions of opening and closing the packaging or in addition the function of metering the product contained in the packaging.

15. Packaging according to claim 1, in which a mirror and/or temperature sensors and/or interactive sensors are integrated into the cap (3).

16. Packaging according to claim 1, comprising at least one functional layer (16) inside the packaging.

17. Packaging according to claim 1, said packaging being a tube (1) or a bottle with a bottom (15).
